(19) United States
(12) Patent Application Publication
(10) Pub. No.: US 2026/0202973 A1
(43) Pub. Date: Jul. 16, 2026

(54) ERROR CONTROL FOR COMPRESSED AND UNCOMPRESSED REGIONS OF MEMORY

(71) Applicant: Micron Technology, Inc., Boise, ID (US)

(72) Inventor: Emanuele Confalonieri, Segrate (IT)

(21) Appl. No.: 19/435,556

(22) Filed: Dec. 29, 2025

Related U.S. Application Data
(60) Provisional application No. 63/745,239, filed on Jan. 14, 2025.

(51) Int. Cl. G06F 3/06

(52) U.S. Cl. CPC G06F 3/0619; G06F 3/0659; G06F 3/0673

(57) ABSTRACT

Methods, systems, and devices for error control for compressed and uncompressed regions of memory are described. A memory system may configure an uncompressed region of memory to operate according to a first error control capability and may configure a compressed region of memory to operate according to a second error control capability. The second error control capability may be capable of correcting relatively more errors than the first error control capability. The memory system may detect and correct a correctable error associated with the uncompressed memory or the compressed memory using the first error control capability or the second error control capability, respectively. In some examples, the memory system may configure the uncompressed region to switch to operating according to the second error control capability based on detecting one or more errors.

### CROSS REFERENCE

The present Application for Patent claims priority to U.S. Patent Application No. 63/745,239 by Confalonieri, entitled “ERROR CONTROL FOR COMPRESSED AND UNCOMPRESSED REGIONS OF MEMORY,” filed January 14, 2025, which is assigned to the assignee hereof, and which is expressly incorporated by reference in its entirety herein.

### TECHNICAL FIELD

The following relates to one or more systems for memory, including error control for compressed and uncompressed regions of memory.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports error control for compressed and uncompressed regions of memory in accordance with examples as disclosed herein.

FIG. 2 shows an example of an architecture that supports error control for compressed and uncompressed regions of memory in accordance with examples as disclosed herein.

FIGS. 3A and 3B show examples of error control schemes that support error control for compressed and uncompressed regions of memory in accordance with examples as disclosed herein.

FIG. 4 shows a block diagram of a memory system that supports error control for compressed and uncompressed regions of memory in accordance with examples as disclosed herein.

FIGS. 5 and 6 show flowcharts illustrating a method or methods that support error control for compressed and uncompressed regions of memory in accordance with examples as disclosed herein.

### DETAILED DESCRIPTION

Some memory systems may include multiple memory dies, and regions that span (e.g., are associated with) one or more of the memory dies. The memory system may include respective regions for storing uncompressed data and respective regions for storing compressed data (e.g., data encoded, restructured, or otherwise modified to reduce its size). The uncompressed regions and the compressed regions may be defined by ranges of logical block addresses (LBAs) within a logical address space of the memory system. The memory system may access the compressed data using different (e.g., relatively larger) access granularities than those used to access the uncompressed data. That is, the compressed regions (e.g., the compressed data) may support different (e.g., increased) access sizes.

Some memory systems may use an error control scheme for detection and correction of data in both the compressed and uncompressed regions. For example, some memory systems may be configured to operate all of the regions of memory according to a type of error control capability, such as a single die data correction (SDDC) scheme or a double die data correction (DDDC) scheme, among other examples. However, utilizing the same error control scheme for correcting both compressed and uncompressed regions (e.g., data) may not result in the memory system performing optimally. For example, because a first access size for accessing the uncompressed data may be smaller than a second access size for accessing the compressed data, a greater quantity of accesses may be required to retrieve sufficient data and parity information (e.g., codewords) from an uncompressed region to support a higher order error correction scheme (e.g., a scheme capable of correcting errors across two or more memory dies) than a quantity of accesses required to support the same error correction scheme in the compressed regions, which may reduce bandwidth and performance, among other examples.

A memory system including one or more uncompressed regions configured to operate according to a first error control capability and one or more compressed regions configured to operate according to a second error control capability is described herein. The first error control capability may be configured in accordance with a first access size of the one or more uncompressed regions and the second error control capability may be configured in accordance with a second access size of the one or more compressed regions, such that the second error control capability may support correction of relatively more errors than the first error control capability (e.g., because the second access size is larger than the first access size). The separate configuration of control capabilities across the different memory regions may provide for enhanced throughput and performance when performing error correction for both compressed data and uncompressed data (e.g., compressed regions and uncompressed regions). The configuration of the uncompressed regions associated with the first error control capability and the configuration of the compressed regions associated with the second error control capability may be performed upon initialization of the memory system (e.g., when the memory system transitions from a first power state, such as an off state or a relatively low power state, to a second power state associated with operation of the memory system). In some examples, the uncompressed regions may be configured to switch (e.g., change) from operating according to the first error control capability to operating according to the second error control capability in response to detection of a correctable error, a threshold quantity of errors, a die failure, or some other condition. The uncompressed regions may thereby support dynamic error control capabilities during operation of the memory system to balance increased reliability and accuracy of data with reduced overhead.

In addition to applicability in memory systems as described herein, techniques for error control for compressed and uncompressed regions of memory may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving the error control capability of compressed regions while maintaining the error control capability of uncompressed regions without adding undesirable complexities associated with increased access sizes for the uncompressed regions and bandwidth reduction, among other benefits.

Features of the disclosure are illustrated and described in the context of systems and architectures. Features of the disclosure are further illustrated and described in the context of error control schemes and flowcharts.

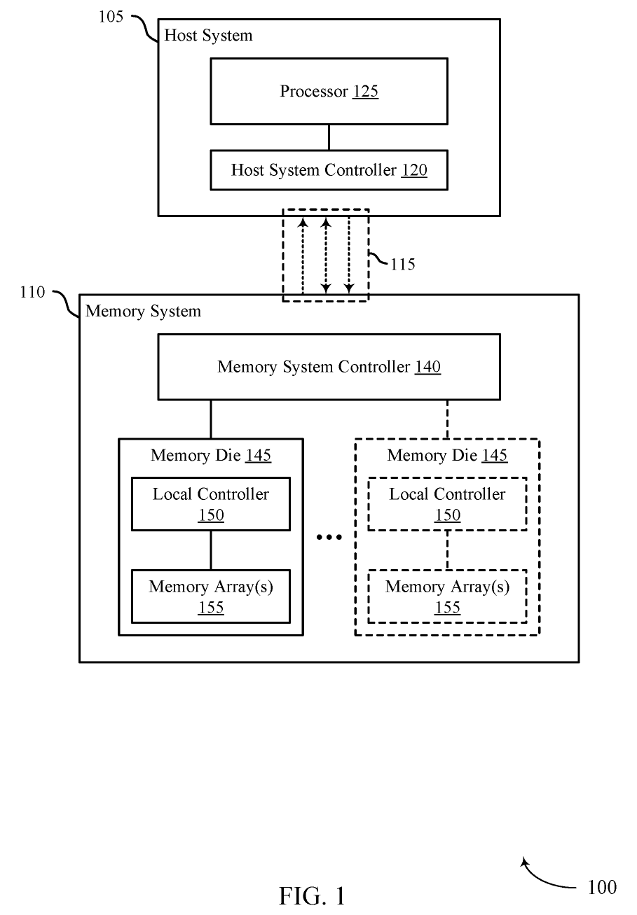

FIG. 1 shows an example of a system 100 that supports error control for compressed and uncompressed regions of memory in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

A host system 105 may include one or more components (e.g., circuitry, processing circuitry, application processing circuitry, one or more processing components) that use memory to execute processes (e.g., applications, functions, computations), any one or more of which may be referred to as or be included in a processor 125 (e.g., an application processor). A processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. A processor 125 may be an example of a central processing unit (CPU), a graphics processing unit (GPU), a general-purpose GPU (GPGPU), or an SoC or a component thereof, among other examples.

A host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating a memory system 110, such as write commands, read commands, configuration signaling or other operational signaling. In some examples, a host system controller 120, or associated functions described herein, may be implemented by or be part of a processor 125. For example, a host system controller 120 may be hardware, instructions (e.g., software, firmware), or a combination thereof implemented by a processor 125 or other component of a host system 105. In various examples, a host system 105 or a host system controller 120 may be referred to as a host.

A memory system 110 provides physical memory locations (e.g., addresses) that may be used or referenced by the system 100. A memory system 110 may include a memory system controller 140 and one or more memory dies 145 (e.g., memory packages, memory dies, portions of a memory die) operable to store data. A memory system 110 may be configurable for operations with different types of host systems 105, and may respond to commands from the host system 105 (e.g., from a host system controller 120). For example, a memory system 110 (e.g., a memory system controller 140) may receive a write command indicating that the memory system 110 is to store data received from a host system 105, or receive a read command indicating that the memory system 110 is to provide data stored in a memory die 145 to a host system 105, or receive a refresh command indicating that the memory system 110 is to refresh data stored in a memory die 145, among other types of commands and operations.

A memory system controller 140 may include at least one of one or more components (e.g., circuitry, logic, instructions) operable to control operations of a memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory dies 145, or a processor 125. In some examples, a memory system controller 140 may control operations of the memory system 110 in cooperation with a host system controller 120, a local controller 150 of a memory die 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory die 145 may include a local controller 150 (e.g., a logic controller, an interface controller, one or more processors) and one or more memory arrays 155. A memory array 155 may be a collection of memory cells (e.g., a two-dimensional array, a three-dimensional array, an array of one or more semiconductor components), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory die 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. In some implementations, at least the channels 115 between a host system 105 and a memory system 110 may include or be referred to as a host interface (e.g., a physical host interface). To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

In some examples, the memory system 110 may include multiple regions that span (e.g., are associated with) one or more of the memory dies 145. The memory system 110 may include respective regions for storing uncompressed data and respective regions for storing compressed data (e.g., data encoded, restructured, or otherwise modified to reduce its size). The uncompressed regions and the compressed regions may be defined by ranges of LBAs within a logical address space of the memory system 110. The memory system 110 may access the compressed data using relatively larger access granularities than those used to access the uncompressed data. That is, the compressed regions (e.g., the compressed data) may support increased access sizes.

Some memory systems 110 may use an error control scheme for detection and correction of data in both the compressed and uncompressed regions. For example, some memory systems 110 may be configured to operate all of the regions of memory according to a type of error control capability, such as an SDDC scheme or a DDDC scheme, among other examples. However, utilizing the same error control scheme for correcting both compressed and uncompressed regions (e.g., data) may not result in the memory system 110 performing optimally. For example, because a first access size for accessing the uncompressed data may be smaller than a second access size for accessing the compressed data, a greater quantity of accesses may be required to retrieve sufficient data and parity information (e.g., codewords) from an uncompressed region to support a higher order error correction scheme (e.g., a scheme capable of correcting errors across two or more memory dies) than a quantity of accesses required to support the same error correction scheme in the compressed regions, which may reduce bandwidth and performance, among other examples.

A memory system 110 including one or more uncompressed regions configured to operate according to a first error control capability and one or more compressed regions configured to operate according to a second error control capability is described herein. The first error control capability may be configured in accordance with a first access size of the one or more uncompressed regions and the second error control capability may be configured in accordance with a second access size of the one or more compressed regions, such that the second error control capability may support correction of relatively more errors than the first error control capability (e.g., because the second access size is larger than the first access size). The separate configuration of control capabilities across the different memory regions within the memory system 110 may provide for enhanced throughput and performance when performing error correction for both compressed data and uncompressed data (e.g., compressed regions and uncompressed regions). The configuration of the uncompressed regions associated with the first error control capability and the configuration of the compressed regions associated with the second error control capability may be performed upon initialization of the memory system 110 (e.g., when the memory system transitions from a first power state, such as an off state or a relatively low power state, to a second power state associated with operation of the memory system 110). In some examples, the uncompressed regions may be configured to switch (e.g., change) from operating according to the first error control capability to operating according to the second error control capability in response to detection of a correctable error, a threshold quantity of errors, a die failure, or some other condition. The uncompressed regions may thereby support dynamic error control capabilities during operation of the memory system 110 to balance increased reliability and accuracy of data with reduced overhead.

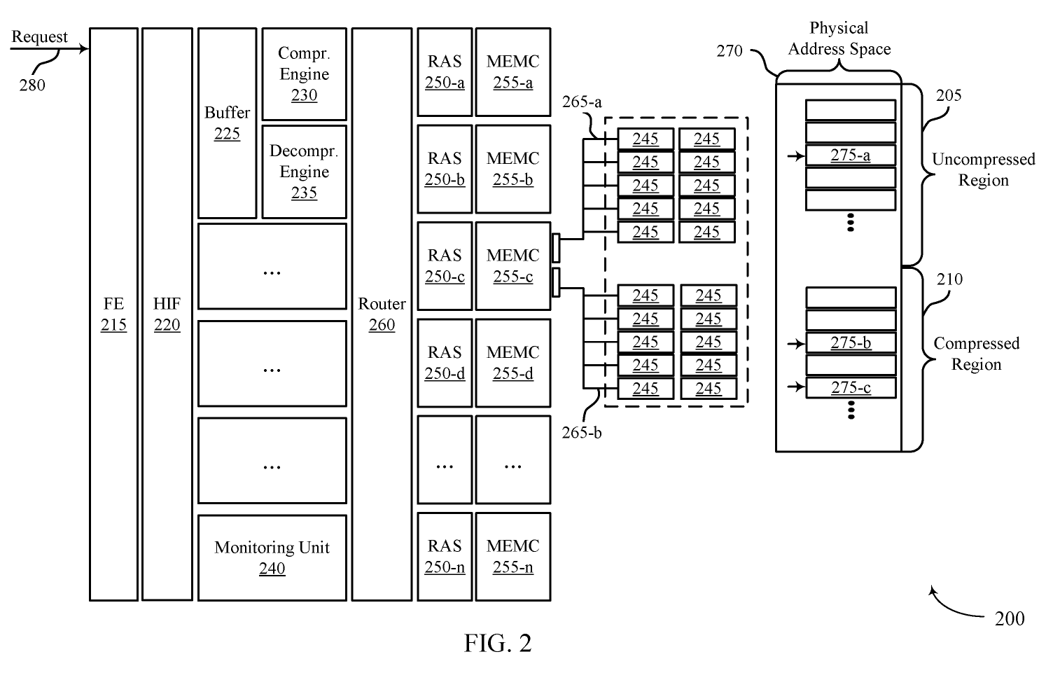

FIG. 2 illustrates an example of an architecture 200 (e.g., a memory architecture) that supports error control for compressed and uncompressed regions of memory in accordance with examples as disclosed herein. The architecture 200 may be implemented in a memory system 110 or one or more components thereof, as described with reference to FIG. 1. For example, the architecture 200 illustrates various components and circuitry included within a memory system 110 (e.g., included in a memory system controller 140 or elsewhere in the memory system 110) and configured to facilitate access operations for data stored within one or more memory dies 245, which may represent examples of the memory dies 145 described with reference to FIG. 1. As described herein, the architecture 200 supports accesses to and from one or more uncompressed regions 205 and one or more compressed regions 210 of data within the memory dies 245. The architecture 200 includes circuitry that supports separate error correction capabilities for the uncompressed regions 205 and the compressed regions 210.

The architecture 200 illustrates a memory system including a memory system controller coupled with one or more memory dies 245. The memory dies 245 may store data within the physical address space 270. The memory system controller (e.g., a CXL-device controller) may be coupled with the memory dies 245 and a host system. The memory system controller may represent an example of the memory system controller 140 described with reference to FIG. 1. The host system may access (e.g., read and write to) the memory system using a logical address space, and the memory system may include one or more mapping tables or other information configured to map each logical address within the logical address space to a respective physical address within the memory dies 245. The memory system may include one or more uncompressed regions 205 for storage of uncompressed data upon initialization of the memory system (e.g., as a default). That is, in some examples, when the memory system is initialized (e.g., transitions from a first power state, such as an off state, to a second power state, such as an on state), each logical address within the logical address space and each physical address within the physical address space 270 may be associated with uncompressed data. After initialization, the host system, the memory system, or both may configure the memory system to include one or more uncompressed regions 205 and one or more compressed regions 210.

The one or more compressed regions 210 and uncompressed regions 205 may be defined by one or more ranges of LBAs (e.g., within a host address space). For example, of 100 LBAs, LBAs 0–50 may be associated with the compressed region 210 and LBAs 50–100 may be associated with the uncompressed regions 205, or there may be some other allocation of LBAs to each region. Some memory systems may include a single port, two ports, or more ports each associated with (e.g., configurable to communicate with) respective host systems. In such cases, each port may be configured to support both compressed and uncompressed data. That is, if two or more ports are each associated with respective ranges of LBAs within the host address space, each range of LBAs may be configured to include an uncompressed LBA range, a compressed LBA range, or both.

The host system may thereby write compressed data to the compressed regions 210 by indicating LBAs within the compressed range of LBAs and may write uncompressed data to the uncompressed regions 205 by indicating LBAs within the uncompressed LBA range. The memory system may use mapping information to map the indicated LBAs to respective physical addresses within the memory dies 245 and may write the data to the physical addresses accordingly. The physical addresses at which the compressed data and the uncompressed data are written within the memory dies 245 may not be sequential. For example, the compressed data may be interleaved with the uncompressed data within the one or more memory dies 245, in some examples. However, each codeword 275 within the memory dies 245 may include one type of data (e.g., either compressed or uncompressed data).

The uncompressed region 205 may be accessed according to a first access granularity (e.g., access size) associated with a first logical page size and a first physical page size. The compressed region 210 may be accessed according to a second access granularity (e.g., access size) associated with a second logical page size and a second physical page size (e.g., a compressed page size). The access size for accessing the compressed region 210 may be greater than an access size for accessing the uncompressed region 205. For example, a single access operation may read or write more bits of data from or to the compressed region 210 than the uncompressed region 205. The larger access size and corresponding page size associated with the compressed region 210 may provide for a codeword 275 used for detection and correction of errors in data within the compressed region 210 that is relatively large. Accordingly, if the same error detection and correction scheme is used in both of the compressed region 210 and the uncompressed region 205, some performance may be lost due to unused correction capability within the compressed region 210.

As described herein, to improve performance and correction reliability, the uncompressed region 205 of the memory system may be configured to operate in accordance with a first error control capability and the compressed region 210 may be configured to operate in accordance with a second error control capability that can correct a greater quantity of errors than the first error control capability. The error control capabilities may represent examples of error detection and correction schemes (e.g., error correction code (ECC) schemes) and may be referred to as reliability, accessibility, and serviceability (RAS) schemes, in some examples. The configuration of the error control schemes to each respective region may be performed upon initialization of the memory system, in some examples. Accordingly, a compressed RAS region and an uncompressed RAS region may be configured at initialization time and may be aligned with (e.g., included in) the compressed region 210 and the uncompressed region 205.

The architecture 200 illustrated in FIG. 2 includes components within a memory system that are configured to facilitate access operations to memory including one or more compressed regions 210 and one or more uncompressed regions 205 according to respective error control schemes for the separate regions. For example, the memory system controller may include a front end (FE) 215, which may represent an example of an interface (e.g., component, circuitry, logic, or any combination thereof) configured to interface between the memory system and a host system, such as the host system 105 illustrated in FIG. 1. The FE 215 may operate according to one or more communication protocols, such as a peripheral component interconnect express (PCIe) protocol on a physical layer and a compute express link (CXL) protocol on a protocol layer, among other examples. The host interface (HIF) 220 may be an intermediate module between the FE 215 and an internal core architecture of the memory system controller.

The internal core architecture of the memory system controller may include one or more components configured to facilitate compression and/or decompression of data transferred between the memory dies 245 and the host system. The memory system controller may include or otherwise be configured to implement the various circuitry, components, and modules illustrated in FIG. 2. For example, the memory system controller may include a compression engine 230 configured to compress data according to one or more compression ratios (CRs) and a decompression engine 235 configured to decompress data according to the one or more CRs. Compressing data may include compressing data within a range of logical addresses to a reduced range of physical addresses within a memory system to increase effective capacity, reduce power consumption associated with manufacturing and operation of the memory system, or both. The memory system controller may additionally include the buffer 225 configured to facilitate the compression and decompression (e.g., a compression buffer). The buffer 225 may temporarily store excess data associated with differences in page sizes due to compression. For example, if the host system transmits an access request 280 associated with a first page size, and the compression engine 230 is to compress the corresponding data, the buffer 225 may buffer a portion of data within the first page size while the compression engine 230 compresses remaining data in the first page size, and the buffer 225 may subsequently transfer the portion of data to the compression engine 230 iteratively until the full page is successfully compressed.

The memory system controller may further include one or more other components configured to support various functions, including encryption, decryption, or the like. In some examples, the memory system controller may include the monitoring unit 240, which may be configured to perform performance monitoring of the memory system. For example, the monitoring unit 240 may obtain, store, and communicate information associated with one or more performance or health metrics of the memory system.

Data may be routed from the FE 215, through the HIF 220, and then through the various modules, including the compression engine 230, the decompression engine 235, the monitoring unit 240, and the like, before entering the router 260. The router 260 may be configured to route data between one or more memory controllers 255 (e.g., memory controllers 255-a, 255-b, 255-c, 255-d, through 255-n) and the internal core circuitry of the memory system controller. That is, the router 260 may collect the common data and requests from the FE 215 and other internal circuitry and distribute the data through one or more target memory controllers 255, or vice versa.

The memory controllers 255 may be coupled with respective sets of one or more memory dies 245 via one or more sub-channels 265. For example, the memory controller 255-c may be coupled with 10 memory dies 245 via a first sub-channel 265-a and with 10 more memory dies 245 via a second sub-channel 265-b (e.g., each sub-channel 265 may drive up to 10 memory dies 245 via a x4 DQ data bus). The memory controllers 255 may each support data transfer of up to some quantity of bits (e.g., 80 bits, or some other quantity). Each memory controller 255 may be coupled with (e.g., and configured to manage) two or more sub-channels 265 that each support a subset of bits from among the quantity supported by the full memory controller 255. For example, the first sub-channel 265-a of the memory controller 255-c may support up to 40 bits and the second sub-channel 265-b of the memory controller 255-c may support up to 40 bits, or some other bit quantities. It is to be understood that the quantities of memory dies 245, sub-channels 265, and memory controllers 255 in FIG. 2 are illustrated for exemplary purposes, and any quantities of the various components may be included or otherwise used within a memory system as described herein. For example, the quantity of memory controllers 255 may be two, four, six, eight, or any other quantity based on a capacity of the corresponding memory module (e.g., a quantity and size of the memory dies 245).

Each memory controller 255 may include or otherwise be coupled with a respective memory sub-channel(s) 265 (e.g., memory PHY) and a respective RAS component 250. The RAS components 250 (e.g., RAS components 250-a, 250-b, 250-c, 250-d, through 250-n) may be configured to facilitate one or more RAS operations or functions for data conveyed via respective memory controllers 255. For example, a RAS component 250 may be configured to support performance of error management and control operations, including error detection, error correction, or both. As described herein, the RAS components 250 may support both of the first error control capability associated with detection and correction of a first quantity of errors within the one or more uncompressed regions 205 and the second error control capability associated with detection and correction of a second quantity of errors within the one or more compressed regions 210, where the second quantity of errors is greater than the first quantity of errors.

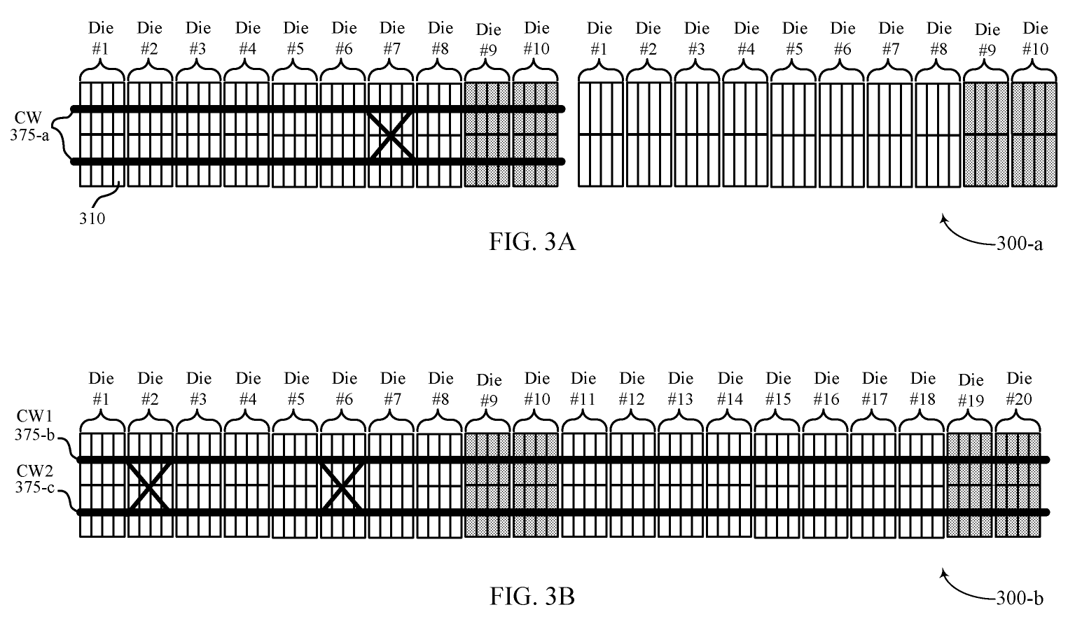

Each RAS component 250 may generate and store parity information to use for performing error correction. The parity information may be stored with the corresponding data as a codeword 275 within the memory dies 245. For example, a set of memory dies 245 (e.g., the 10 memory dies 245 coupled with the first sub-channel 265-a) may store multiple codewords, where each codeword includes data and parity information stored across one or more respective symbols of each memory die 245 in the set, as described and illustrated in further detail elsewhere herein, including with reference to FIGS. 3A-3B. As the size of a codeword increases, a quantity of errors that may be corrected via an error correction operation may increase. Accordingly, larger codeword sizes may improve reliability and performance. However, larger codeword sizes may additionally, or alternatively, increase overhead and reduce bandwidth within the memory system due to more data being retrieved during an error correction operation.

The uncompressed region 205 may support a first logical page size and a first physical page size, which may be the same as the first logical page size (e.g., 64 bytes, or some other size). That is, to access uncompressed data, the host system may transmit an access request 280 that includes a request to read or write data and includes a range of LBAs according to the logical page size. The memory system may access the data in the physical address space 270 using the same physical page size (e.g., without any compression or decompression). For example, the FE 215 may receive the request 280 and forward the request 280 to the HIF 220. Since the request 280 indicates LBAs within the uncompressed LBA regions, the HIF 220 may forward the request 280 and corresponding data (e.g., for a write command) directly to the router 260, and may bypass the compression engine 230, the decompression engine 235, and the buffer 225. In some examples, the HIF 220 may forward the request 280 and corresponding data to one or more of the other components before the data is sent to the router 260 if other functions are requested, such as to decode the data, or the like. The router 260 may route the requested data to a respective memory controller 255-c and corresponding RAS component 250-c based on the LBAs indicated via the request 280.

The RAS component 250-c may generate (e.g., for a write operation) a set of parity bits associated with each page of data indicated via the request (e.g., 16 parity bytes, or some other quantity) and may store the data and the parity bits in the respective memory dies 245 as a codeword 275-a. The codeword for the uncompressed RAS region may include 80 bytes, in this example (e.g., CW = 64 bytes data + 16 bytes parity = 80 bytes). If the request 280 is a read command, the codeword 275-a may be retrieved from the memory dies 245, routed via the memory controller 255-c, and the RAS component 250-c may perform an error detection and correction operation on the codeword 275-a before routing the data back to the router 260, the HIF 220, and the FE 215, which will forward the requested data to the host system. If the RAS component 250-c detects a correctable error within the data, the RAS component 250-c may use the codeword and corresponding parity bits to correct the error before transmitting the data back to the host system.

The uncompressed regions 205 of memory may thereby be accessed in accordance with a first access size (e.g., a first physical access granularity of 80 bytes) that is the same as a first codeword size (e.g., 65 bytes data and 16 bytes parity information). In the example of FIG. 2, the physical access granularity for the uncompressed regions 205 may be supported via a single sub-channel 265. The codeword 275-a may be sent via the first sub-channel 265-a to respective symbols within each of the corresponding 10 memory dies 245. In some examples, the codeword 275-a may be sent with a burst length of 16 via the first sub-channel 265-a having a capacity of 40 bits. The first access size for the uncompressed regions 205 may support correction of a first quantity of errors within a single memory die 245, as described in further detail elsewhere herein, including with reference to FIGS. 3A-3B.

The compressed region 210 may support a second logical page size (referred to as an uncompressed page size) and a second physical page size (referred to as a compressed page size). The uncompressed page size may be larger than the first logical page size of the uncompressed region 205. For example, the host system may work, at the logical level, with a larger range of data (e.g., more LBAs) for accessing compressed data than uncompressed data. The request 280 for accessing compressed data may thereby indicate LBAs associated with a second logical page size that is larger than a logical page size of the uncompressed data by a factor, n, where n may be any value (e.g., 2, 4, 8, 16, or any other value). That is, because the data is to be compressed, the host system may request to write a relatively larger range of LBAs in a given page.

The memory system may access the data in the physical address space 270 using the second physical page size, which is smaller than the second logical page size (e.g., the uncompressed page) after compression of the data. For example, the FE 215 may receive the request 280 and forward the request 280 to the HIF 220. Since the request 280 indicates LBAs within the compressed LBA regions, if the request 280 is a write command, the HIF 220 may forward the request 280 and corresponding data to the compression engine 230 and the buffer 225. In some examples, the HIF 220 may additionally, or alternatively, forward the request 280 and corresponding data to one or more of the other components before or after the data is sent to the compression engine 230 if other functions are requested, such as to decode the data, or the like.

The compression engine 230 may compress the data according to a CR. The CR may be some value, such as 3, 4, 6, or some other value that is based on a type of the data. For example, if the data is repetitive, the CR may be greater, as the data may be more compressible, than if the data includes non-repetitive entries. The resulting second physical page size of the data after compression may be a factor of the uncompressed page size. For example, the compressed page may be equal to ⌈n/CR⌉ multiplied by the first logical page size of the memory system without compression (e.g., ⌈n/CR⌉ x 64 bytes), where n may be the factor by which the uncompressed logical page size indicated via the request 280 is larger than the uncompressed logical page size for the uncompressed regions 205.

As an example, if the default page size for uncompressed data in the memory system is 64 bytes, and n is 16, the uncompressed logical page size indicated via the request may be around one kilobyte (KB) (e.g., 16 multiplied by 64 = 1 KB). If a CR for a set of data indicated via the request 280 is six, a compressed page size after the compression engine 230 compresses the data may be 192 bytes because ⌈n/CR⌉= ⌈2.6667⌉, which may be rounded to three, and 3 x 64 bytes = 192 bytes. If the CR for the data is four, the compressed page size may be 256 bytes, and if the CR for the data is three, the compressed page size may be 384 bytes. The higher the CR, the more the data may be compressed, which may include fitting the same amount of data (e.g., the same logical address range) into a smaller compressed physical page size for storage within the physical address space 270 of the memory dies 245.

After the compression engine 230 compresses the data, the compressed data may be forwarded to the router 260, which may forward the compressed data to a respective memory controller 255-c based on the logical addresses indicated via the request 280. The respective RAS component 250-c associated with the target memory controller 255-c may generate parity information for the data in accordance with an error control capability supported by the compressed memory regions 210. The amount of parity information that is generated by the RAS component 250-c may be based on a compression factor, m, and the default amount of parity for uncompressed data. For example, if the RAS component 250-c generates 16 bytes of parity for uncompressed data, and the compression factor, m, is four, the RAS component 250-c may generate 64 bytes of parity for each compressed page of data.

A size of a codeword 275 for the compressed region 210 may be equal to the size of the codeword 275-a for the uncompressed region 205 multiplied by the compression factor, m (e.g., m(64 + 16) bytes). The compression factor, m, may be configured based on an expected, predicted, or averaged CR. For example, on average, the CR for data may be around four, such that the compression factor may be equal to four for a given memory system in order to improve a likelihood that the codeword size is relatively similar in value to an average page size after compression. In some examples, the codeword size for the compressed region 210 may include a single codeword or more than one codeword 275. For example, a size of a codeword for the compressed region may be equal to a single codeword 275-b or to two codewords 275-b and 275-c, where each codeword 275 may span 20 symbols, as described with reference to FIGS. 3A-3B. The memory system may determine an access size based on the compressed page size and the codeword size (e.g., access size = ⌈cp/cw⌉ x cw).

If the compressed page size of the data after compression (e.g., a second access size) is less than the size of the codeword for the compressed region 210 (e.g., a third access size), the memory system (e.g., the RAS component 250-c, or some other component) may pad the data in the compressed page size with one or more random bytes of data (e.g., null bits or other default bit values) to generate a codeword 275-b having the third access size. For example, if the compressed page size is 192 bytes, and the codeword size is 256 + 64 bytes, the access size may be one (e.g., access one compressed page), and the memory system may pad the compressed page with 64 bytes to get to 256 total bytes (e.g., the size of data in the codeword).

If the compressed page size of the data after compression (e.g., a second access size) is greater than the size of the codeword 275-b (e.g., a third access size), the memory system may generate another codeword, such as the codeword 275-c, which may include additional parity bits and the remaining data that overflows from the codeword 275-b. The memory system may pad the codeword 275-c with one or more bytes to fill the full size of the codeword 275-c. For example, if the compressed page size is 384 bytes, and the codeword size is 256 + 65 bytes, the access size may be two (e.g., access two compressed pages), and the memory system may generate a second codeword 275-c and pad the second codeword 275-c with addition bits to get to 512 total bytes (e.g., the size of data in two codewords).

The codeword 275-b or both of the codewords 275-b and 275-c may be written to the physical address space 270 within the memory dies 245 accordingly (e.g., in response to the request 280 being a write command). In some examples (e.g., if m=2 or more), both of the sub-channels 265-a and 265-b may be locked and used for conveying the codeword(s) 275 to the memory dies 245. The locking logic may be embedded in the RAS component 250-c, in some examples. The two sub-channels 265-a and 265-b may support access to the requested page with ⌈n/CR⌉ and a burst length of 16 on the 80 byte memory channel coupled with or otherwise managed by the memory controller 255-c (e.g., having full bandwidth if n/CR is greater than or equal to one).

If the request 280 is a read command, the codeword 275-b may be read from the memory dies 245 based on the LBAs indicated via the request 280. The RAS component 250-c may determine a compressed page size of the data based on a CR for the data and the factor, n (e.g., compressed page size = ⌈n/CR⌉ x 64 bytes). If the compressed page size is less than the size of the codeword 275-b, the RAS component 250-c may discard one or more bits of data from the codeword 275-b before performing any error correction. If the compressed page size is greater than the size of the codeword 275-b, the RAS component 250-c may read another codeword, such as the codeword 275-c from the memory dies 245, and may discard any extra bits in the codeword 275-c before performing error correction (e.g., any bits associated with a difference between the size of two codewords and the compressed page size). If the RAS component 250-c detects a correctable error in the data remaining after discarding the one or more bits, the RAS component 250-c may correct the error using the parity bits within the codeword 275-b or both the codewords 275-b and 275-c if both were read.

The RAS component 250-c may forward the corrected and compressed data to the router 260, which may forward the data to the decompression engine 235 and the buffer 225. The decompression engine 235 may decompress the data according to the CR. The decompression engine 235 may forward the decompressed data to the HIF 220, which may forward the decompressed data to the host system via the FE 215 in response to the request 280.

As described herein, the memory architecture 200 may thereby support access operations to both compressed data and uncompressed data stored within the memory dies 245. The RAS components 250 may be configured to facilitate a first error control capability for compressed data and a second error control capability for uncompressed data. Examples of these error control capabilities are described in further detail elsewhere herein, including with reference to FIGS. 3A-3B.

FIGS. 3A and 3B show examples of error control schemes 300-a and 300-b that support error control for compressed and uncompressed regions of memory in accordance with examples as disclosed herein. The error control schemes 300-a and 300-b may implement or be implemented by aspects of the system 100 or the architecture 200 described with reference to FIGS. 1 and 2. For example, the error control schemes 300-a and 300-b illustrate codewords 375 stored across multiple memory dies, which may represent examples of the codewords 275 and the memory dies 245 described with reference to FIG. 2. The codewords 375 may be generated and used by one or more RAS components, such as the RAS components 250 described with reference to FIG. 2, or other components within a memory system controller coupled with the memory dies.

In the examples of FIGS. 3A and 3B, each of the memory dies may include four data pins (e.g., DQ[0:3]) and read/write accesses may operate according to a burst length of 16. For example, at each access operation (e.g., each read or write), 16 bits per data pin (DQ) may be accessed. These 16 bits may be organized in two symbols 310 of eight bits each. Accordingly, eight symbols 310 of eight bits per memory die may be accessed. In some examples, one or more memory dies may be configured as parity dies that store parity information. For example, two out of every 10 memory dies may be configured as parity dies, such as the memory dies 9 and 10 in the example of FIG. 3A and the memory dies 9, 10, 19, and 20 in the example of FIG. 3B. It is to be understood that the memory die sizes and quantities illustrated in FIGS. 3A and 3B are for exemplary purposes, and the described techniques may be supported by any quantity and size of memory dies, including those not illustrated.

The error control scheme 300-a illustrates an SDDC scheme for application to uncompressed regions. Upon initialization of the memory system, the uncompressed regions may be configured to operate in accordance with a first error control capability, which may be the SDDC scheme (e.g., a Reed Solomon (RS) SDDC scheme). As described with reference to FIG. 2, the uncompressed memory regions may be accessed according to a first access size. The first access size may be 80 bytes, in some examples, which may be the same as a size of the codeword 375-a (e.g., 64 bytes of data and 16 bytes of parity). The SDDC scheme may be managed according to a codeword size of 80 bytes (e.g., a 1 x RS8(80,64) scheme). As such, the access size for the uncompressed regions of memory may be the same as the codeword size for the SDDC scheme. By performing error correction for data stored in the uncompressed regions of memory using SDDC, the memory system may support reliable error correction without accessing the data more than once for a given error correction.

If the memory system (e.g., the RAS component) detects a correctable error associated with data stored to the memory die #6, for example, where the data is within the uncompressed LBA range, the memory system may access the codeword 375-a according to the first access size, and may correct the error using the codeword 375-a before returning the data to a host system. The codeword 375-a may be stored across 10 memory dies (e.g., memory dies #1 through #10) and may not be store within the second set of 10 memory dies because the uncompressed memory may be accessed using a single sub-channel, such as the sub-channel 265-a described with reference to FIG. 2. The second set of 10 memory dies illustrated in FIG. 3A may not be accessed as part of the SDDC scheme for the uncompressed data in this example. The memory system may be capable of correcting one or more errors within a single memory die using the SDDC scheme. If errors are identified on more than one memory die, the SDDC scheme may not be capable of correcting all of the errors.

The error control scheme 300-b illustrates a DDDC scheme for application to compressed regions of memory, uncompressed regions of memory after a threshold quantity of errors, or both. The compressed regions of memory within a memory system may be configured, upon initialization of the memory system to operate in accordance with a second error control capability, which may be the DDDC scheme, in some examples (e.g., a RS DDDC scheme). As described with reference to FIG. 2, the compressed memory regions may be accessed according to a second access size (e.g., a compressed page size), which may be associated with a larger codeword size, such as two codewords 375. For example, a single access to compressed data may access both of the codewords 375-b and 375-c (e.g., 128 bytes of data and 32bytes of parity). The DDDC scheme may be managed according to two codewords 375 (e.g., a 2 x RS8(80,64) scheme). As such, the larger page size in the compressed memory regions may support targeting a relatively larger codeword size (e.g., two codewords 375) without reducing bandwidth, which may improve performance.

If the memory system (e.g., the RAS component) detects a correctable error associated with data stored to the memory die #6 and the memory die #2, for example, where the data is within the compressed LBA range, the memory system may access the codeword 375-b and the codeword 375-c according to a second access size for compressed data, which may be determined as described with reference to FIG. 2. The memory system may use the codewords 375-b and 375-c to correct the errors before returning the data to the host system. The codeword 375-b may be stored across symbols in each of the memory dies #1 through #20, and the codeword 375-c may be stored across symbols in each of the memory dies #1 through #20 in accordance with the memory system using two sub-channels to access compressed data, such as both of the sub-channels 265-a and 265-b, as described with reference to FIG. 2. The memory system may be capable of correcting one or more errors within two memory dies using the DDDC scheme. If errors are identified on more than two memory dies, the DDDC scheme may not be capable of correcting all of the errors.

In some examples described herein, the memory system may support adaptable or dynamic error control capabilities for each of the compressed region and the uncompressed region. For example, if a correctable error is detected within an uncompressed region of a memory die, such as the memory die #6, the SDDC scheme may be used to correct the error, and the memory system may subsequently configure the uncompressed region to switch to a second error control capability, such as the DDDC scheme, for subsequent accesses. Such dynamic error control capability switches may occur in response to detection of any correctable error, in response to detection of at least a threshold quantity of errors, in response to detection of a die failure, or any combination thereof.

If a memory die fails, the memory system may continue to operate using the remaining memory dies, and the uncompressed memory region may switch from the first error control capability to the second error control capability that is capable of correcting more errors than the first error control capability. For example, the uncompressed memory regions may be configured to switch from SDDC to DDDC.

In any case, when a condition is detected for adaptive switching between error control capabilities, the memory system may start to perform two accesses to retrieve two codewords when accessing uncompressed data and may use the two codewords to perform DDDC for error correction within the remaining memory dies, as illustrated by the error control scheme 300-b. The memory system may continue to use the codewords 375-b and 375-c to correct errors in compressed data regions using the DDDC scheme.

If a second correctable error is detected, a second threshold quantity of errors is detected, a second memory die, such as the memory die #2, experiences a failure, or any combination thereof, the memory system may switch to a die replacement and DDDC scheme. For example, the memory system may replace the two failed memory dies #2 and #6 with the parity dies. The memory dies #9 and #10 in FIG. 3B may be repurposed to store data instead of parity bits. All of the parity information for the codewords 375 stored across the memory dies #1 through #18 may be stored in memory dies #19 and #20. Both of the uncompressed and compressed data regions may be accessed using the replacement memory dies and DDDC scheme.

The memory system may thereby configure uncompressed memory regions to operate according to an SDDC scheme and compressed memory regions to operate according to a DDDC scheme upon initialization (e.g., when the memory system switches from a first power state to a second power state). The memory system may support an adaptive error control scheme such that the uncompressed memory regions are configured to support DDDC or some other higher order error control scheme capable of correcting a greater quantity of errors after a threshold quantity of errors, a failed die, or both are detected.

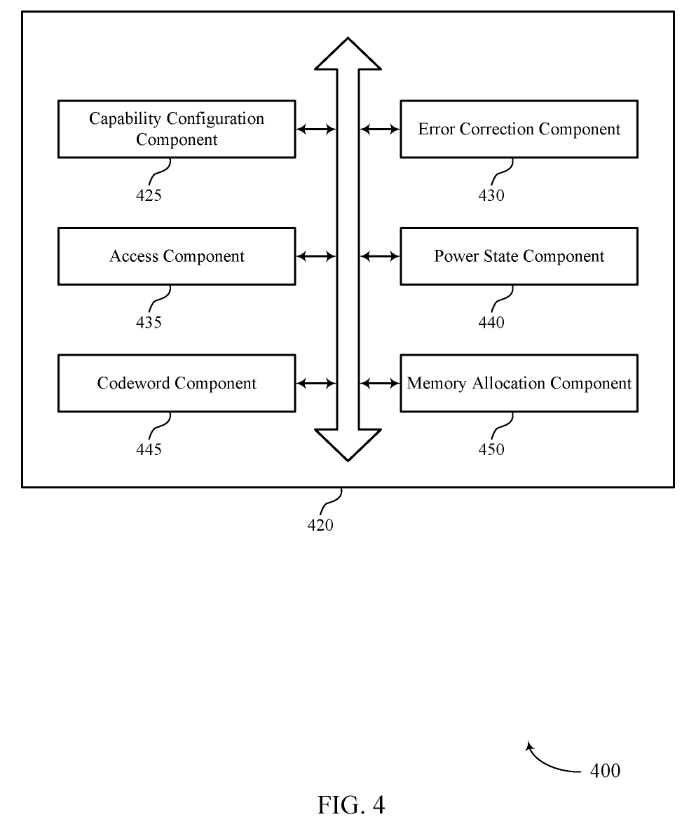

FIG. 4 shows a block diagram 400 of a memory system 420 that supports error control for compressed and uncompressed regions of memory in accordance with examples as disclosed herein. The memory system 420 may be an example of aspects of a memory system as described with reference to FIGS. 1 through 3. The memory system 420, or various components thereof, may be an example of means for performing various aspects of error control for compressed and uncompressed regions of memory as described herein. For example, the memory system 420 may include a capability configuration component 425, an error correction component 430, an access component 435, a power state component 440, a codeword component 445, a memory allocation component 450, or any combination thereof. Each of these components, or components of subcomponents thereof (e.g., one or more processors, one or more memories), may communicate, directly or indirectly, with one another (e.g., via one or more buses).

The capability configuration component 425 may be configured as or otherwise support a means for configuring an uncompressed region of the memory system to operate in accordance with a first error control capability of a plurality of error control capabilities. In some examples, the capability configuration component 425 may be configured as or otherwise support a means for configuring a compressed region of the memory system to operate in accordance with a second error control capability of the plurality of error control capabilities, the second error control capability for correcting a greater quantity of errors than the first error control capability. The error correction component 430 may be configured as or otherwise support a means for correcting a correctable error associated with data stored to the memory system in accordance with the first error control capability or the second error control capability based on the data being within the uncompressed region or the compressed region.

In some examples, the uncompressed region is associated with a first access size, and the access component 435 may be configured as or otherwise support a means for receiving a first access command. In some examples, the uncompressed region is associated with a first access size, and the access component 435 may be configured as or otherwise support a means for accessing a first codeword having the first access size based on receiving the first access command.

In some examples, the compressed region is associated with a second access size, and the access component 435 may be configured as or otherwise support a means for receiving a second access command. In some examples, the compressed region is associated with a second access size, and the access component 435 may be configured as or otherwise support a means for accessing a second codeword having a third access size based on receiving the second access command.

In some examples, the third access size is greater than the second access size, and the codeword component 445 may be configured as or otherwise support a means for discarding one or more bits of data based on the second access command being a read command. In some examples, the third access size is greater than the second access size, and the codeword component 445 may be configured as or otherwise support a means for padding data written to the second codeword based on the second access command being a write command.

In some examples, the third access size is smaller than the second access size, and the codeword component 445 may be configured as or otherwise support a means for reading a third codeword having the third access size and discarding one or more bits of data based on the second access command being a read command. In some examples, the third access size is smaller than the second access size, and the codeword component 445 may be configured as or otherwise support a means for padding data written to the second codeword with dummy data, the third codeword, or both based on the second access command being a write command.

In some examples, the error correction component 430 may be configured as or otherwise support a means for determining an occurrence of the correctable error after configuring the uncompressed region to operate in accordance with the first error control capability and the compressed region to operate in accordance with the second error control capability, where correcting the correctable error is based on determining the occurrence of the correctable error.

In some examples, the error correction component 430 may be configured as or otherwise support a means for determining an occurrence of a single correctable error associated with a first memory die, where the uncompressed region includes at least a portion of the first memory die, and where the single correctable error is corrected in accordance with the first error control capability based on the uncompressed region including at least the portion of the first memory die.

In some examples, the error correction component 430 may be configured as or otherwise support a means for determining an occurrence of a first correctable error associated with a second memory die and a second correctable error associated with a third memory die, where the compressed region includes at least a portion of the second memory die and the third memory die, and where the first correctable error and the second correctable error are corrected in accordance with the second error control capability based on the compressed region including at least the portion of the second memory die and the third memory die.

In some examples, the power state component 440 may be configured as or otherwise support a means for transitioning, by the memory system, from a first power state to a second power state that is higher than the first power state, where configuring the uncompressed region of the memory system to operate in accordance with the first error control capability and configuring the compressed region of the memory system to operate in accordance with the second error control capability is based on the memory system transitioning from the first power state to the second power state.

In some examples, the memory system includes a plurality of uncompressed regions after transitioning from the first power state to the second power state, and the memory allocation component 450 may be configured as or otherwise support a means for allocating a second uncompressed region of the plurality of uncompressed regions as the compressed region.

In some examples, the first error control capability includes a single die data correction capability and the second error control capability includes a double die data correction capability.

In some examples, the uncompressed region is associated with a first range of logical block addresses and the compressed region is associated with a second range of logical block addresses different than the first range of logical block addresses.

In some examples, the capability configuration component 425 may be configured as or otherwise support a means for configuring an uncompressed region of the memory system to operate in accordance with a first error control capability, where the memory system includes a compressed region operable in accordance with a second error control capability. In some examples, the capability configuration component 425 may be configured as or otherwise support a means for configuring the uncompressed region of the memory system associated to operate in accordance with the second error control capability based on correcting a correctable error associated with data stored to the memory system using the first error control capability.

In some examples, the error correction component 430 may be configured as or otherwise support a means for determining an occurrence of the correctable error after configuring the uncompressed region to operate in accordance with the first error control capability. In some examples, the error correction component 430 may be configured as or otherwise support a means for correcting the correctable error using the first error control capability based on the data being associated with the uncompressed region of the memory system.

In some examples, the error correction component 430 may be configured as or otherwise support a means for determining an occurrence of a second error and a third error associated with data stored to the memory system, where the second error and the third error each include a correctable error or an uncorrectable error. In some examples, the capability configuration component 425 may be configured as or otherwise support a means for configuring the compressed region of the memory system to operate in accordance with a third error control capability based on determining the occurrence of the second error and the third error.

In some examples, the second error and the third error each include a correctable error, and the error correction component 430 may be configured as or otherwise support a means for correcting the second error and the third error using the second error control capability based on determining the occurrence of the second error and the third error.

In some examples, the first error control capability includes a single die data correction capability, the second error control capability includes a double die data correction capability, and the third error control capability includes a die replacement capability.

In some examples, the uncompressed region is associated with a first range of logical block addresses and the compressed region is associated with a second range of logical block addresses different than the first range of logical block addresses.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

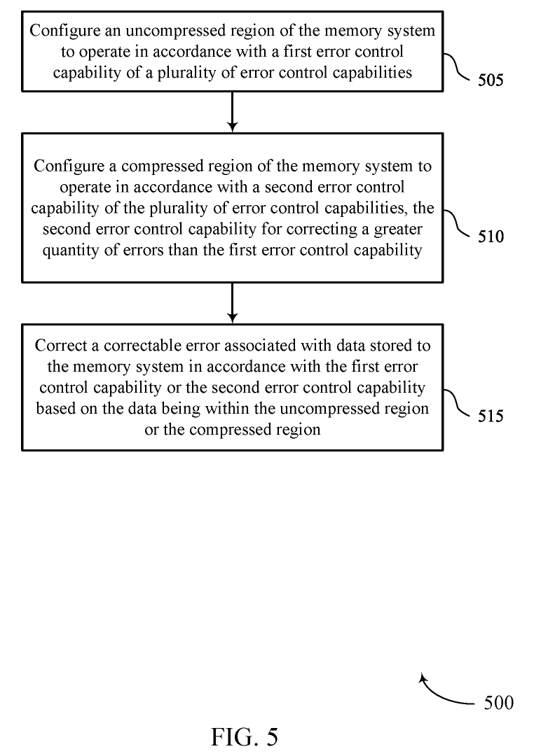

FIG. 5 shows a flowchart illustrating a method 500 that supports error control for compressed and uncompressed regions of memory in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include configuring an uncompressed region of the memory system (e.g., uncompressed region 205) to operate in accordance with a first error control capability (e.g., an SDDC capability) of a plurality of error control capabilities. In some examples, aspects of the operations of 505 may be performed by a capability configuration component 425 (e.g., within a memory system controller 140) as described with reference to FIG. 4.

At 510, the method may include configuring a compressed region of the memory system (e.g., the compressed region 210) to operate in accordance with a second error control capability (e.g., a DDDC capability) of the plurality of error control capabilities, the second error control capability for correcting a greater quantity of errors than the first error control capability. In some examples, aspects of the operations of 510 may be performed by a capability configuration component 425 (e.g., within a memory system controller 140) as described with reference to FIG. 4.

At 515, the method may include correcting a correctable error associated with data stored to the memory system in accordance with the first error control capability or the second error control capability based on the data being within the uncompressed region or the compressed region. In some examples, aspects of the operations of 515 may be performed by an error correction component 430 as described with reference to FIG. 4. For example, the memory system may include an error correction component, such as a RAS component 250 as described with reference to FIG. 2 that is configured to perform error correction according to one or more error control capabilities.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for configuring an uncompressed region of the memory system to operate in accordance with a first error control capability of a plurality of error control capabilities; configuring a compressed region of the memory system to operate in accordance with a second error control capability of the plurality of error control capabilities, the second error control capability for correcting a greater quantity of errors than the first error control capability; and correcting a correctable error associated with data stored to the memory system in accordance with the first error control capability or the second error control capability based on the data being within the uncompressed region or the compressed region.

Aspect 2: The method, apparatus, or non-transitory computer-readable medium of aspect 1, where the uncompressed region is associated with a first access size and the method, apparatuses, and non-transitory computer-readable medium further includes operations, features, circuitry, logic, means, or instructions, or any combination thereof for receiving a first access command and accessing a first codeword having the first access size based on receiving the first access command.

Aspect 3: The method, apparatus, or non-transitory computer-readable medium of any of aspects 1 through 2, where the compressed region is associated with a second access size and the method, apparatuses, and non-transitory computer-readable medium further includes operations, features, circuitry, logic, means, or instructions, or any combination thereof for receiving a second access command and accessing a second codeword having a third access size based on receiving the second access command.

Aspect 4: The method, apparatus, or non-transitory computer-readable medium of aspect 3, where the third access size is greater than the second access size and the method, apparatuses, and non-transitory computer-readable medium further includes operations, features, circuitry, logic, means, or instructions, or any combination thereof for discarding one or more bits of data based on the second access command being a read command and padding data written to the second codeword based on the second access command being a write command.

Aspect 5: The method, apparatus, or non-transitory computer-readable medium of aspect 3, where the third access size is smaller than the second access size and the method, apparatuses, and non-transitory computer-readable medium further includes operations, features, circuitry, logic, means, or instructions, or any combination thereof for reading a third codeword having the third access size and discarding one or more bits of data based on the second access command being a read command and padding data written to the second codeword with dummy data, the third codeword, or both based on the second access command being a write command.

Aspect 6: The method, apparatus, or non-transitory computer-readable medium of any of aspects 1 through 5, further including operations, features, circuitry, logic, means, or instructions, or any combination thereof for determining an occurrence of the correctable error after configuring the uncompressed region to operate in accordance with the first error control capability and the compressed region to operate in accordance with the second error control capability, where correcting the correctable error is based on determining the occurrence of the correctable error.

Aspect 7: The method, apparatus, or non-transitory computer-readable medium of any of aspects 1 through 6, further including operations, features, circuitry, logic, means, or instructions, or any combination thereof for determining an occurrence of a single correctable error associated with a first memory die, where the uncompressed region includes at least a portion of the first memory die, and where the single correctable error is corrected in accordance with the first error control capability based on the uncompressed region including at least the portion of the first memory die.

Aspect 8: The method, apparatus, or non-transitory computer-readable medium of any of aspects 1 through 6, further including operations, features, circuitry, logic, means, or instructions, or any combination thereof for determining an occurrence of a first correctable error associated with a second memory die and a second correctable error associated with a third memory die, where the compressed region includes at least a portion of the second memory die and the third memory die, and where the first correctable error and the second correctable error are corrected in accordance with the second error control capability based on the compressed region including at least the portion of the second memory die and the third memory die.

Aspect 9: The method, apparatus, or non-transitory computer-readable medium of any of aspects 1 through 8, further including operations, features, circuitry, logic, means, or instructions, or any combination thereof for transitioning, by the memory system, from a first power state to a second power state that is higher than the first power state, where configuring the uncompressed region of the memory system to operate in accordance with the first error control capability and configuring the compressed region of the memory system to operate in accordance with the second error control capability is based on the memory system transitioning from the first power state to the second power state.

Aspect 10: The method, apparatus, or non-transitory computer-readable medium of aspect 9, where the memory system includes a plurality of uncompressed regions after transitioning from the first power state to the second power state and the method, apparatuses, and non-transitory computer-readable medium further includes operations, features, circuitry, logic, means, or instructions, or any combination thereof for allocating a second uncompressed region of the plurality of uncompressed regions as the compressed region.

Aspect 11: The method, apparatus, or non-transitory computer-readable medium of any of aspects 1 through 10, where the first error control capability includes a single die data correction capability and the second error control capability includes a double die data correction capability.

Aspect 12: The method, apparatus, or non-transitory computer-readable medium of any of aspects 1 through 11, where the uncompressed region is associated with a first range of logical block addresses and the compressed region is associated with a second range of logical block addresses different than the first range of logical block addresses.

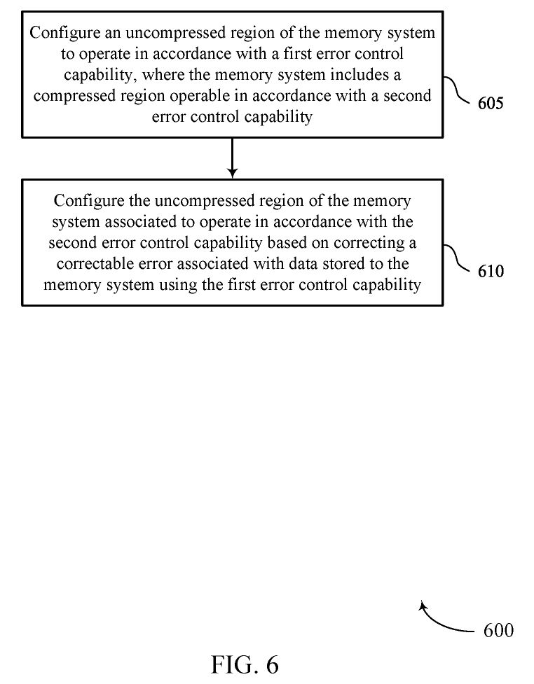

FIG. 6 shows a flowchart illustrating a method 600 that supports error control for compressed and uncompressed regions of memory in accordance with examples as disclosed herein. The operations of method 600 may be implemented by a memory system or its components as described herein. For example, the operations of method 600 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 605, the method may include configuring an uncompressed region of the memory system (e.g., the uncompressed region 205) to operate in accordance with a first error control capability (e.g., SDDC), where the memory system includes a compressed region (e.g., the compressed region 210) operable in accordance with a second error control capability (e.g., DDDC). In some examples, aspects of the operations of 605 may be performed by a capability configuration component 425 as described with reference to FIG. 4.

At 610, the method may include configuring the uncompressed region of the memory system associated to operate in accordance with the second error control capability (e.g., DDDC) based on correcting a correctable error associated with data stored to the memory system using the first error control capability. In some examples, aspects of the operations of 610 may be performed by a capability configuration component 425 as described with reference to FIG. 4. For example, a memory system controller 140 may configure the uncompressed region to switch from an SDDC scheme to a DDDC scheme in response to correction of an error—e.g., as described herein, including with reference to FIGS. 3A and 3B.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 13: A method, apparatus, or non-transitory computer-readable medium including operations, features, circuitry, logic, means, or instructions, or any combination thereof for configuring an uncompressed region of the memory system to operate in accordance with a first error control capability, where the memory system includes a compressed region operable in accordance with a second error control capability and configuring the uncompressed region of the memory system associated to operate in accordance with the second error control capability based on correcting a correctable error associated with data stored to the memory system using the first error control capability.

Aspect 14: The method, apparatus, or non-transitory computer-readable medium of aspect 13, further including operations, features, circuitry, logic, means, or instructions, or any combination thereof for determining an occurrence of the correctable error after configuring the uncompressed region to operate in accordance with the first error control capability and correcting the correctable error using the first error control capability based on the data being associated with the uncompressed region of the memory system.

Aspect 15: The method, apparatus, or non-transitory computer-readable medium of any of aspects 13 through 14, further including operations, features, circuitry, logic, means, or instructions, or any combination thereof for determining an occurrence of a second error and a third error associated with data stored to the memory system, where the second error and the third error each include a correctable error or an uncorrectable error and configuring the compressed region of the memory system to operate in accordance with a third error control capability based on determining the occurrence of the second error and the third error.

Aspect 16: The method, apparatus, or non-transitory computer-readable medium of aspect 15, where the second error and the third error each include a correctable error and the method, apparatuses, and non-transitory computer-readable medium further includes operations, features, circuitry, logic, means, or instructions, or any combination thereof for correcting the second error and the third error using the second error control capability based on determining the occurrence of the second error and the third error.

Aspect 17: The method, apparatus, or non-transitory computer-readable medium of any of aspects 15 through 16, where the first error control capability includes a single die data correction capability, the second error control capability includes a double die data correction capability, and the third error control capability includes a die replacement capability.

Aspect 18: The method, apparatus, or non-transitory computer-readable medium of any of aspects 13 through 17, where the uncompressed region is associated with a first range of logical block addresses and the compressed region is associated with a second range of logical block addresses different than the first range of logical block addresses.

It should be noted that the aspects described herein describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. A conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or may be an indirect conductive path that includes intermediate components, such as switches, transistors, or other components. In some examples, the flow of signals between the connected components may be interrupted for a time, for example, using one or more intermediate components such as switches or transistors.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, instructions (e.g., code, software, firmware, logic) executed by a processing system (e.g., one or more processors, one or more controllers, control circuitry, processing circuitry, logic circuitry), or any combination thereof that is configured to cause a respective apparatus, device, or system to perform the described functions. If implemented as instructions executed by a processing system, the functions may be stored on or transmitted over as one or more instructions on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof, that are configured to cause the performance of the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
configure an uncompressed region of the memory system to operate in accordance with a first error control capability of a plurality of error control capabilities;
configure a compressed region of the memory system to operate in accordance with a second error control capability of the plurality of error control capabilities, the second error control capability for correcting a greater quantity of errors than the first error control capability; and
correct a correctable error associated with data stored to the memory system in accordance with the first error control capability or the second error control capability based on the data being within the uncompressed region or the compressed region.

2. The memory system of claim 1, wherein the uncompressed region is associated with a first access size, and the processing circuitry is further configured to cause the memory system to:
receive a first access command; and
access a first codeword having the first access size based on receiving the first access command.

3. The memory system of claim 1, wherein the compressed region is associated with a second access size, and the processing circuitry is further configured to cause the memory system to:
receive a second access command; and
access a second codeword having a third access size based on receiving the second access command.

4. The memory system of claim 3, wherein the third access size is greater than the second access size, and the processing circuitry is further configured to cause the memory system to:
discard one or more bits of data based on the second access command being a read command; or
pad data written to the second codeword based on the second access command being a write command.

5. The memory system of claim 3, wherein the third access size is smaller than the second access size, and the processing circuitry is further configured to cause the memory system to:
read a third codeword having the third access size and discarding one or more bits of data based on the second access command being a read command; or
pad data written to the second codeword with dummy data, the third codeword, or both based on the second access command being a write command.

6. The memory system of claim 1, wherein the processing circuitry is further configured to cause the memory system to:
determine an occurrence of the correctable error after configuring the uncompressed region to operate in accordance with the first error control capability and the compressed region to operate in accordance with the second error control capability, wherein correcting the correctable error is based on determining the occurrence of the correctable error.

7. The memory system of claim 1, wherein the processing circuitry is further configured to cause the memory system to:
determine an occurrence of a single correctable error associated with a first memory die, wherein the uncompressed region comprises at least a portion of the first memory die, and wherein the single correctable error is corrected in accordance with the first error control capability based on the uncompressed region including at least the portion of the first memory die.

8. The memory system of claim 1, wherein the processing circuitry is further configured to cause the memory system to:
determine an occurrence of a first correctable error associated with a second memory die and a second correctable error associated with a third memory die, wherein the compressed region comprises at least a portion of the second memory die and the third memory die, and wherein the first correctable error and the second correctable error are corrected in accordance with the second error control capability based on the compressed region including at least the portion of the second memory die and the third memory die.

9. The memory system of claim 1, wherein the processing circuitry is further configured to cause the memory system to:
transition, by the memory system, from a first power state to a second power state that is higher than the first power state, wherein configuring the uncompressed region of the memory system to operate in accordance with the first error control capability and configuring the compressed region of the memory system to operate in accordance with the second error control capability is based on the memory system transitioning from the first power state to the second power state.

10. The memory system of claim 9, wherein the memory system comprises a plurality of uncompressed regions after transitioning from the first power state to the second power state, and the processing circuitry is further configured to cause the memory system to:
allocate a second uncompressed region of the plurality of uncompressed regions as the compressed region.

11. The memory system of claim 1, wherein the first error control capability comprises a single die data correction capability and the second error control capability comprises a double die data correction capability.

12. The memory system of claim 1, wherein the uncompressed region is associated with a first range of logical block addresses and the compressed region is associated with a second range of logical block addresses different than the first range of logical block addresses.

13. A memory system, comprising:
one or more memory devices; and
processing circuitry coupled with the one or more memory devices and configured to cause the memory system to:
configure an uncompressed region of the memory system to operate in accordance with a first error control capability, wherein the memory system comprises a compressed region operable in accordance with a second error control capability; and
configure the uncompressed region of the memory system associated to operate in accordance with the second error control capability based on correcting a correctable error associated with data stored to the memory system using the first error control capability.

14. The memory system of claim 13, wherein the processing circuitry is further configured to cause the memory system to:
determine an occurrence of the correctable error after configuring the uncompressed region to operate in accordance with the first error control capability; and
correct the correctable error using the first error control capability based on the data being associated with the uncompressed region of the memory system.

15. The memory system of claim 13, wherein the processing circuitry is further configured to cause the memory system to:
determine an occurrence of a second error and a third error associated with data stored to the memory system, wherein the second error and the third error each comprise a correctable error or an uncorrectable error; and
configure the compressed region of the memory system to operate in accordance with a third error control capability based on determining the occurrence of the second error and the third error.

16. The memory system of claim 15, wherein the second error and the third error each comprise a correctable error, and the processing circuitry is further configured to cause the memory system to:
correct the second error and the third error using the second error control capability based on determining the occurrence of the second error and the third error.

17. The memory system of claim 15, wherein the first error control capability comprises a single die data correction capability, the second error control capability comprises a double die data correction capability, and the third error control capability comprises a die replacement capability.

18. The memory system of claim 13, wherein the uncompressed region is associated with a first range of logical block addresses and the compressed region is associated with a second range of logical block addresses different than the first range of logical block addresses.

19. A method at a memory system, comprising:
configuring an uncompressed region of the memory system to operate in accordance with a first error control capability of a plurality of error control capabilities;
configuring a compressed region of the memory system to operate in accordance with a second error control capability of the plurality of error control capabilities, the second error control capability for correcting a greater quantity of errors than the first error control capability; and
correcting a correctable error associated with data stored to the memory system in accordance with the first error control capability or the second error control capability based on the data being within the uncompressed region or the compressed region.

20. The method of claim 19, wherein the uncompressed region is associated with a first access size, the method further comprising:
receiving a first access command; and
accessing a first codeword having the first access size based on receiving the first access command.

21. The method of claim 19, wherein the compressed region is associated with a second access size, the method further comprising:
receiving a second access command; and
accessing a second codeword having a third access size based on receiving the second access command.

22. The method of claim 21, wherein the third access size is greater than the second access size, the method further comprising:
discarding one or more bits of data based on the second access command being a read command; or
padding data written to the second codeword based on the second access command being a write command.

23. The method of claim 21, wherein the third access size is smaller than the second access size, the method further comprising:
reading a third codeword having the third access size and discarding one or more bits of data based on the second access command being a read command; or
padding data written to the second codeword with dummy data, the third codeword, or both based on the second access command being a write command.

24. The method of claim 19, further comprising:
determining an occurrence of the correctable error after configuring the uncompressed region to operate in accordance with the first error control capability and the compressed region to operate in accordance with the second error control capability, wherein correcting the correctable error is based on determining the occurrence of the correctable error.

25. The method of claim 19, further comprising:
determining an occurrence of a single correctable error associated with a first memory die, wherein the uncompressed region comprises at least a portion of the first memory die, and wherein the single correctable error is corrected in accordance with the first error control capability based on the uncompressed region including at least the portion of the first memory die.

26. The method of claim 19, further comprising:
determining an occurrence of a first correctable error associated with a second memory die and a second correctable error associated with a third memory die, wherein the compressed region comprises at least a portion of the second memory die and the third memory die, and wherein the first correctable error and the second correctable error are corrected in accordance with the second error control capability based on the compressed region including at least the portion of the second memory die and the third memory die.

27. The method of claim 19, further comprising:
transitioning, by the memory system, from a first power state to a second power state that is higher than the first power state, wherein configuring the uncompressed region of the memory system to operate in accordance with the first error control capability and configuring the compressed region of the memory system to operate in accordance with the second error control capability is based on the memory system transitioning from the first power state to the second power state.

28. A method at a memory system, comprising:
configuring an uncompressed region of the memory system to operate in accordance with a first error control capability, wherein the memory system comprises a compressed region operable in accordance with a second error control capability; and
configuring the uncompressed region of the memory system associated to operate in accordance with the second error control capability based on correcting a correctable error associated with data stored to the memory system using the first error control capability.

29. The method of claim 28, further comprising:
determining an occurrence of the correctable error after configuring the uncompressed region to operate in accordance with the first error control capability; and
correcting the correctable error using the first error control capability based on the data being associated with the uncompressed region of the memory system.

30. The method of claim 28, further comprising:
determining an occurrence of a second error and a third error associated with data stored to the memory system, wherein the second error and the third error each comprise a correctable error or an uncorrectable error; and
configuring the compressed region of the memory system to operate in accordance with a third error control capability based on determining the occurrence of the second error and the third error.

31. The method of claim 28, wherein the uncompressed region is associated with a first range of logical block addresses and the compressed region is associated with a second range of logical block addresses different than the first range of logical block addresses.

32. A non-transitory computer-readable medium storing code, the code comprising instructions executable by one or more processors to:
configure an uncompressed region of a memory system to operate in accordance with a first error control capability of a plurality of error control capabilities;
configure a compressed region of the memory system to operate in accordance with a second error control capability of the plurality of error control capabilities, the second error control capability for correcting a greater quantity of errors than the first error control capability; and
correct a correctable error associated with data stored to the memory system in accordance with the first error control capability or the second error control capability based on the data being within the uncompressed region or the compressed region.

33. The non-transitory computer-readable medium of claim 32, wherein the uncompressed region is associated with a first access size, and the instructions are further executable by the one or more processors to:
receive a first access command; and
access a first codeword having the first access size based on receiving the first access command.

34. The non-transitory computer-readable medium of claim 32, wherein the compressed region is associated with a second access size, and the instructions are further executable by the one or more processors to:
receive a second access command; and
access a second codeword having a third access size based on receiving the second access command.

35. The non-transitory computer-readable medium of claim 32, wherein the instructions are further executable by the one or more processors to:
determine an occurrence of the correctable error after configuring the uncompressed region to operate in accordance with the first error control capability and the compressed region to operate in accordance with the second error control capability, wherein correcting the correctable error is based on determining the occurrence of the correctable error.
